(19) United States
(12) Patent Application Publication
(10) Pub. No.: US 2012/0080568 A1
(43) Pub. Date: Apr. 5, 2012

(54) Hose Trolley for Pneumatic Tool

(76) Inventor: Ling-Hong Zhang, Guiren Shiang (TW)

(21) Appl. No.: 12/897,874

(22) Filed: Oct. 5, 2010

(51) Int. Cl. B65H 75/44; F15D 1/02

(52) U.S. Cl. 248/80; 138/37

(57) ABSTRACT

A hose trolley includes a support unit (3) and a connection unit (4) mounted on the support unit. The support unit includes a spool (30) and a hose (31) wound around the spool. The connection unit includes a control box (40) mounted on the support unit, a connecting pipe (41) connected between the hose and the control box, and at least one fitting (42) connected to the control box. Thus, the connection unit includes a plurality of fittings connected to a plurality of pneumatic tools so that the hose trolley can co-operate with a plurality of pneumatic tools. In addition, the control box of the connection unit can be operated to regulate the air pressure so that the operator can directly regulate the air pressure without having to move to the air compressor to regulate the air pressure.

### BACKGROUND OF THE INVENTION

1. Field of the Invention

The present invention relates to a hose trolley and, more particularly, to a hose trolley for a pneumatic tool.

2. Description of the Related Art

A conventional hose trolley 1 in accordance with the prior art shown in FIG. 1 comprises a support frame 11 and a hose 10 mounted on the support frame 11. The hose 10 has a first side connected to an air compressor 2 and a second side connected to a pneumatic tool 5 to connect the air compressor 2 with the pneumatic tool 5. The air compressor 2 has a larger volume and a heavier weight so that the air compressor 2 is positioned in place without movement. In assembly, the first end of the hose 10 is connected to an air pipe of the air compressor 2. Then, the second end of the hose 10 is extended outward from the support frame 11 to reach the pneumatic tool 5. Then, the second end of the hose 10 is connected with the pneumatic tool 5. Thus, the pneumatic tool 5 is connected to and driven by the air compressor 2.

However, the second end of the hose 10 is extended outward from the support frame 11 to reach the pneumatic tool 5 at a far working position so that when the moving path of the hose 31 is turned during movement of the hose 31, the hose 31 has to be bent, thereby easily blocking or choking the air flow in the hose 31, and thereby greatly affecting operation of the pneumatic tool 5. In addition, the hose trolley 1 is only available for a single pneumatic tool 5 and cannot co-operate with multiple pneumatic tools 5, thereby decreasing the versatility of the hose trolley 1. Further, the pneumatic tool 5 is far distant from the air compressor 2 so that when the air pressure of the pneumatic tool 5 is too large or too small, the operator has to move to the air compressor 2 to regulate the air pressure, thereby greatly causing inconvenience to the operator, and thereby decreasing the working efficiency of the pneumatic tool 5.

### BRIEF SUMMARY OF THE INVENTION

In accordance with the present invention, there is provided a hose trolley, comprising a support unit and a connection unit mounted on the support unit. The support unit includes a spool and a hose wound around the spool. The connection unit includes a control box mounted on the support unit, a connecting pipe connected between the hose of the support unit and the control box, and at least one fitting connected to the control box. The control box of the connection unit is a pressure regulator that can directly regulate the air pressure of the at least one fitting of the connection unit. The control box of the connection unit is connected between the connecting pipe and the at least one fitting of the connection unit so that the hose of the support unit is connected to the at least one fitting of the connection unit through the control box and the connecting pipe of the connection unit. The at least one fitting of the connection unit is connected to the connecting pipe of the connection unit through the control box of the connection unit. The at least one fitting and the connecting pipe of the connection unit are located at two opposite sides of the connection unit. Preferably, the connection unit includes two fittings each connected to the control box. The connection unit is secured on a side of the support unit.

The primary objective of the present invention is to provide a hose trolley that can be used to drive multiple pneumatic tools simultaneously.

According to the primary advantage of the present invention, the connection unit includes a plurality of fittings connected to a plurality of pneumatic tools so that the hose trolley can co-operate with a plurality of pneumatic tools simultaneously so as to enhance the working efficiency.

According to another advantage of the present invention, when the air pressure supplied to the pneumatic tools is too large or too small, the control box of the connection unit can be operated to regulate the air pressure so that the operator can directly regulate the air pressure by operation of the control box of the connection unit without having to move to the air compressor to regulate the air pressure, thereby facilitating the operator regulating the air pressure, and thereby enhancing the working efficiency.

According to a further advantage of the present invention, the support unit is directly moved to the working position to extend the hose from the spool so that the hose is moved with the support unit and will not be bent due to turning of the moving path of the support unit such that the air is delivered through the hose smoothly without blockage.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a conventional hose trolley in accordance with the prior art.

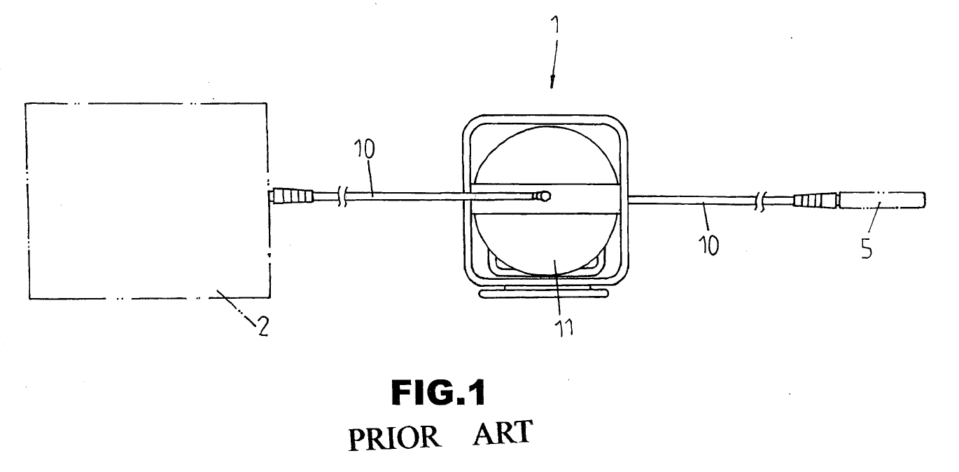

FIG. 2 is a perspective view of a hose trolley in accordance with the preferred embodiment of the present invention.

FIG. 3 is a front view showing the hose trolley as shown in FIG. 1 is connected between an air compressor and multiple pneumatic tools.

FIG. 4 is a perspective view of a hose trolley in accordance with another preferred embodiment of the present invention.

FIG. 5 is a front view showing the hose trolley as shown in FIG. 4 is connected between an air compressor and multiple pneumatic tools.

FIG. 6 is a perspective view of a hose trolley in accordance with another preferred embodiment of the present invention.

FIG. 7 is a front view showing the hose trolley as shown in FIG. 6 is connected between an air compressor and multiple pneumatic tools.

### DETAILED DESCRIPTION OF THE INVENTION

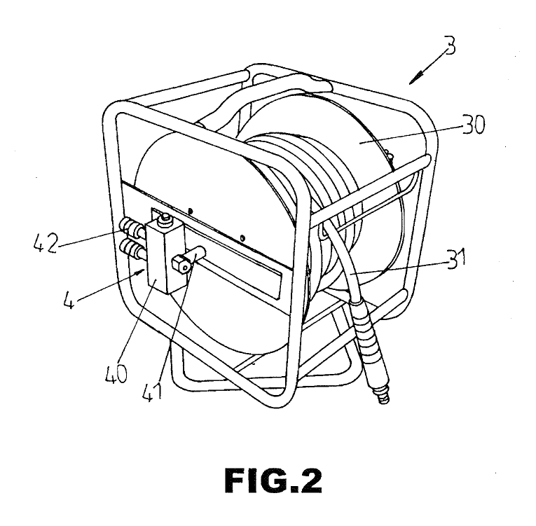

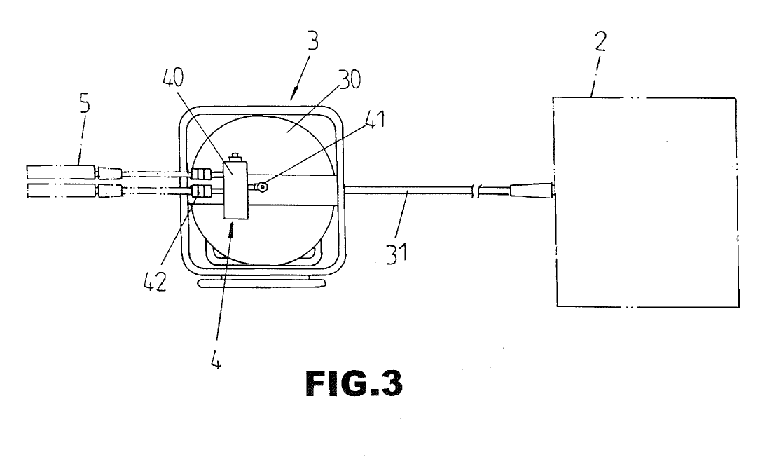

Referring to the drawings and initially to FIGS. 2 and 3, a hose trolley in accordance with the preferred embodiment of the present invention comprises a support unit 3 and a connection unit 4 mounted on the support unit 3.

The support unit 3 includes a spool 30 and a hose 31 wound around the spool 30. The connection unit 4 is secured on a side of the support unit 3 and includes a control box 40 mounted on the support unit 3, a connecting pipe 41 connected between the hose 31 of the support unit 3 and the control box 40, and at least one fitting 42 connected to the control box 40. The control box 40 of the connection unit 4 is connected between the connecting pipe 41 and the at least one fitting 42 of the connection unit 4 so that the hose 31 of the support unit 3 is connected to the at least one fitting 42 of the connection unit 4 through the control box 40 and the connecting pipe 41 of the connection unit 4. The at least one fitting 42 of the connection unit 4 is connected to the connecting pipe 41 of the connection unit 4 through the control box 40 of the connection unit 4. The at least one fitting 42 and the connecting pipe 41 of the connection unit 4 are located at two opposite sides of the connection unit 4. In the preferred embodiment of the present invention, the connection unit 4 includes two fittings 42 each connected to the control box 40.

When in use, the hose trolley is mounted between an air compressor 2 and at least one pneumatic tool 5 to connect the air compressor 2 with the at least one pneumatic tool 5. In assembly, the hose 31 of the support unit 3 is connected to an air pipe of the air compressor 2. Then, the support unit 3 is lifted and delivered to the working position of the at least one pneumatic tool 5. At this time, the hose 31 of the support unit 3 is extended outward from the spool 30 to facilitate movement of the support unit 3. Then, the at least one fitting 42 of the connection unit 4 is connected to the at least one pneumatic tool 5. Thus, the at least one pneumatic tool 5 is connected to and driven by the air compressor 2.

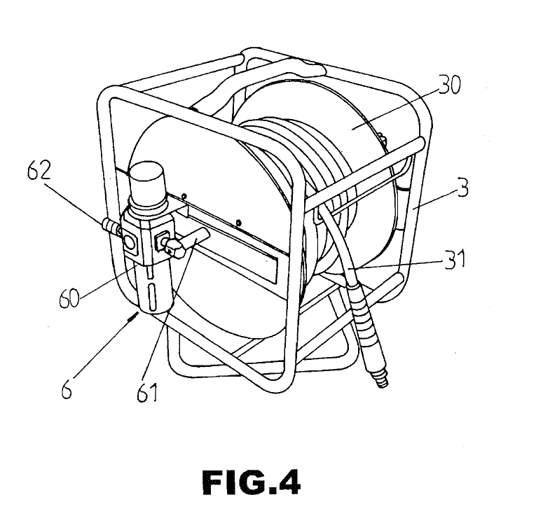

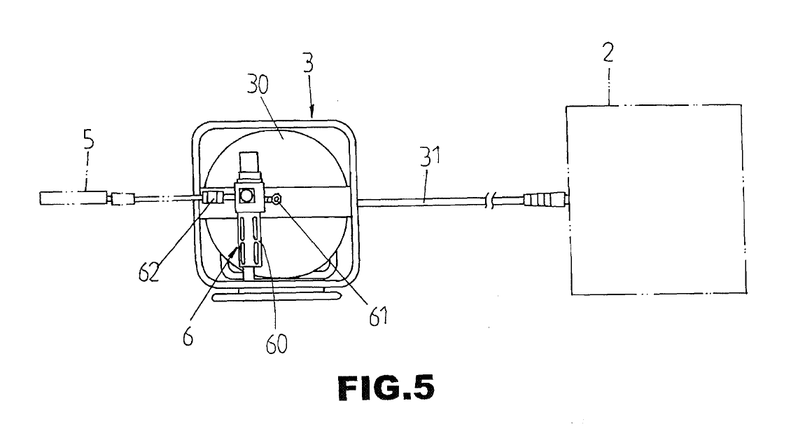

Referring to FIGS. 4 and 5, the connection unit 6 is secured on a side of the support unit 3 and includes a control box 60 mounted on the support unit 3, a connecting pipe 61 connected between the hose 31 of the support unit 3 and the control box 60, and at least one fitting 62 connected to the control box 60. Preferably, the control box 60 of the connection unit 6 is a pressure regulator that can directly regulate the air pressure of the at least one fitting 62 of the connection unit 6.

When in use, the hose 31 of the support unit 3 is connected to the air compressor 2. Then, the support unit 3 is lifted and delivered to the working position of the at least one pneumatic tool 5. At this time, the hose 31 of the support unit 3 is extended outward from the spool 30 to facilitate movement of the support unit 3. Then, the at least one fitting 62 of the connection unit 6 is connected to the at least one pneumatic tool 5. Thus, the at least one pneumatic tool 5 is connected to and driven by the air compressor 2.

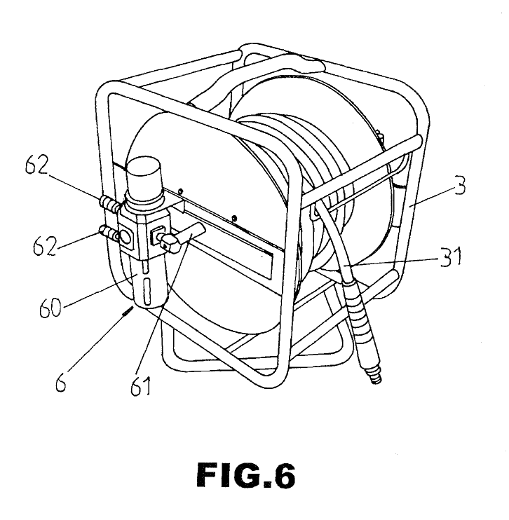

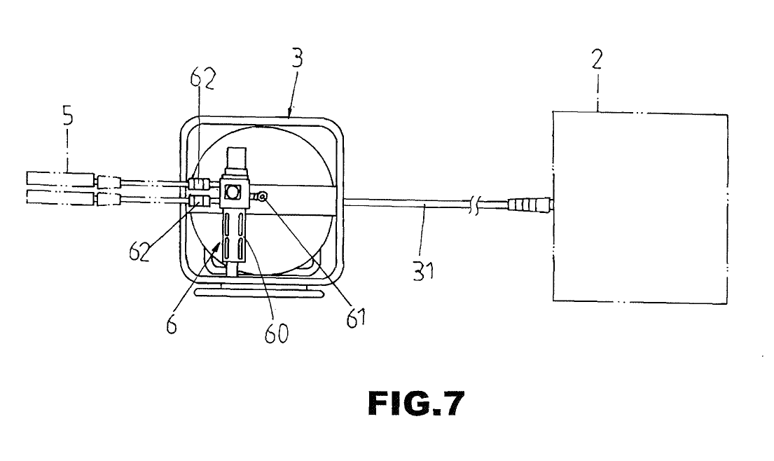

Referring to FIGS. 6 and 7, the connection unit 6 includes two fittings 62 each connected to the control box 60.

Accordingly, the connection unit 6 includes a plurality of fittings 62 connected to a plurality of pneumatic tools 5 so that the hose trolley can co-operate with a plurality of pneumatic tools 5 simultaneously so as to enhance the working efficiency. In addition, when the air pressure supplied to the pneumatic tools 5 is too large or too small, the control box 60 of the connection unit 6 can be operated to regulate the air pressure so that the operator can directly regulate the air pressure by operation of the control box 60 of the connection unit 6 without having to move to the air compressor 2 to regulate the air pressure, thereby facilitating the operator regulating the air pressure, and thereby enhancing the working efficiency. Further, the support unit 3 is directly moved to the working position to extend the hose 31 from the spool 30 so that the hose 31 is moved with the support unit 3 and will not be bent due to turning of the moving path of the support unit 3 such that the air is delivered through the hose 31 smoothly without blockage. Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hose trolley, comprising:
a support unit; and
a connection unit mounted on the support unit;
wherein the support unit includes a spool; and
a hose wound around the spool;
the connection unit includes:
a control box mounted on the support unit;
a connecting pipe connected between the hose of the support unit and the control box; and
at least one fitting connected to the control box.

2. The hose trolley of claim 1, wherein the control box of the connection unit is a pressure regulator that regulates an air pressure of the at least one fitting of the connection unit.

3. The hose trolley of claim 1, wherein
the control box of the connection unit is connected between the connecting pipe and the at least one fitting of the connection unit;
the hose of the support unit is connected to the at least one fitting of the connection unit through the control box and the connecting pipe of the connection unit.

4. The hose trolley of claim 1, wherein the at least one fitting of the connection unit is connected to the connecting pipe of the connection unit through the control box of the connection unit.

5. The hose trolley of claim 1, wherein the at least one fitting and the connecting pipe of the connection unit are located at two opposite sides of the connection unit.

6. The hose trolley of claim 1, wherein the connection unit includes two fittings each connected to the control box.

7. The hose trolley of claim 1, wherein the connection unit is secured on a side of the support unit.
